(19) United States
(12) Patent Application Publication
(10) Pub. No.: US 2024/0255709 A1
(43) Pub. Date: Aug. 1, 2024

(54) OPTICAL FIBER BUNDLE, OPTICAL CONNECTION STRUCTURE, AND METHOD FOR MANUFACTURING OPTICAL FIBER BUNDLE

(71) Applicant: SUMITOMO ELECTRIC INDUSTRIES, LTD., Osaka-shi (JP)

(72) Inventor: Takahiro KIKUCHI, Osaka-shi (JP)

(73) Assignee: SUMITOMO ELECTRIC INDUSTRIES, LTD., Osaka-shi (JP)

(21) Appl. No.: 18/421,056

(22) Filed: Jan. 24, 2024

(30) Foreign Application Priority Data
Jan. 27, 2023 (JP) 2023-011189

(51) Int. Cl. G02B 6/38

(52) U.S. Cl. CPC G02B 6/3885; G02B 6/3869; G02B 6/3877

(57) ABSTRACT

An optical fiber bundle includes a ferrule, a holding portion, and a plurality of optical fibers. The holding portion has a fiber accommodating hole. The plurality of optical fibers each have a glass fiber and a coating portion. The glass fiber has a first diameter portion and a second diameter portion. The coating portion is formed by covering a glass fiber continuous with the second diameter portion with a coating. The coating portion includes a first portion led out from the fiber accommodating hole. The coating of the first portion of each of the plurality of optical fibers is fixed to the coating of the first portion of at least one optical fiber among the other optical fibers. An arrangement order of the coating portions in the fiber accommodating hole is the same as an arrangement order of the plurality of optical fibers at the front end of the ferrule.

### CROSS REFERENCE

The present application claims priority based on Japanese Patent Application No. 2023-011189 filed on Jan. 27, 2023, the entire contents of which are incorporated herein by reference.

### TECHNICAL FIELD

The present disclosure relates to an optical fiber bundle, an optical connection structure, and a method for manufacturing an optical fiber bundle.

### BACKGROUND

Patent Literature 1 (Japanese Unexamined Patent Publication No. 2017-167299) and Patent Literature 2 (Japanese Unexamined Patent Publication No. 2013-68891) disclose an optical fiber bundle in which a plurality of optical fibers are inserted into a ferrule. In the optical fiber bundle described in Patent Literature 1, the plurality of optical fibers are twisted inside the ferrule (capillary) to be aligned in a close packed structure. In the optical fiber bundle described in Patent Literature 2, the optical fibers subjected to diameter reduction process by etching are housed in the ferrule.

### SUMMARY

An optical fiber bundle according to an aspect of the present disclosure is an optical fiber bundle for optically coupling a plurality of optical fibers to a multicore optical fiber. The optical fiber bundle includes a ferrule, a holding portion, and a plurality of optical fibers. The ferrule extends along a first direction. The ferrule has a front end in the first direction, a rear end opposite to the front end in the first direction, and a first fiber accommodating hole. The first fiber accommodating hole is a hole including a first portion located at the front end, a second portion located at the rear end, and an inner diameter transition portion connecting the first portion and the second portion to each other. The second portion has a larger inner diameter than an inner diameter of the first portion. The holding portion has a second fiber accommodating hole extending along the first direction. The second fiber accommodating hole communicates with the first fiber accommodating hole at the rear end of the ferrule. A plurality of optical fibers each have a glass fiber and a coating portion. The glass fiber includes a first diameter portion, a second diameter portion having a larger diameter than a diameter of the first diameter portion, and a tapered portion connecting the first diameter portion and the second diameter portion. At least the first diameter portion, the tapered portion, and the second diameter portion extend along the first direction. The coating portion is formed by covering a portion of the glass fiber continuous with the second diameter portion with a coating. The first diameter portion of each of the plurality of optical fibers is inserted into the first portion of the first fiber accommodating hole. The tapered portion of each of the plurality of optical fibers is inserted into the second portion of the first fiber accommodating hole. A boundary between the second diameter portion of each of the plurality of optical fibers and the coating portion of each of the plurality of optical fibers is inserted into the second fiber accommodating hole. The coating portion of each of the plurality of optical fibers includes a first portion led out from the second fiber accommodating hole and a second portion away from the second fiber accommodating hole. The coating of the first portion of each of the plurality of optical fibers is fixed to the coating of the first portion of the coating portion of at least one optical fiber among the other optical fibers. An arrangement order of the coating portions of the plurality of optical fibers in the second fiber accommodating hole is the same as an arrangement order of the first diameter portions of the plurality of optical fibers at the front end of the ferrule.

### BRIEF DESCRIPTION OF THE DRAWINGS

FIG. 1 is a perspective view illustrating an optical connection structure according to an embodiment;

FIG. 2 is an exploded perspective view of the optical connection structure illustrated in FIG. 1;

FIG. 3 is a cross-sectional view of the optical connection structure illustrated in FIG. 1 along the line III-III;

FIG. 4 is a view illustrating a tip of a multicore fiber and an end surface of a ferrule;

FIG. 5 is a view illustrating tips of a plurality of optical fibers and an end surface of the ferrule;

FIG. 6 is a schematic view illustrating an optical fiber;

FIG. 7 is a perspective view illustrating the plurality of optical fibers extending to the outside of the flange;

FIG. 8 is a perspective view of the plurality of optical fibers;

FIG. 9 is a schematic cross-sectional view illustrating an inner hole of the ferrule;

FIG. 10 is a schematic cross-sectional view illustrating the plurality of optical fibers inserted into the inner hole of the ferrule and an inner hole of the flange;

FIG. 11 is a perspective view illustrating a form of the plurality of optical fibers in the inner hole of the ferrule and the inner hole of the flange;

FIG. 12 is a flowchart illustrating a method for manufacturing an optical fiber bundle;

FIG. 13 is a schematic view illustrating the plurality of optical fibers inserted into the inner hole of the ferrule and an inner hole of the flange;

FIG. 14 is a schematic front view illustrating an example of an arrangement of the plurality of optical fibers in the inner hole of the flange;

FIG. 15 is a schematic perspective view illustrating an example of an arrangement of the plurality of optical fibers at a front end of the ferrule;

FIG. 16 is a schematic perspective view illustrating an example of an arrangement of the plurality of optical fibers at the front end of the ferrule;

FIG. 17 is a schematic perspective view illustrating an example of an arrangement of the plurality of optical fibers at the front end of the ferrule; and

FIG. 18 is a view illustrating a fan-in/fan-out device including the optical connection structure illustrated in FIG. 1.

### DETAILED DESCRIPTION

### Problems to be Solved by Invention

In the optical fiber bundle described in Patent Literature 2, when the plurality of optical fibers are inserted into the ferrule, the positions of the plurality of optical fibers may be deviated from each other along a longitudinal direction. In this case, it is necessary to determine an insertion amount into the ferrule so that the coating portion of the optical fiber deviated rearmost is disposed in the ferrule, and thus, the insertion amount of the optical fiber other than the optical fiber deviated rearmost into the ferrule becomes excessive. In a case where the plurality of optical fibers are subjected to diameter reduction process, when the insertion amount is excessively large, the optical fiber abuts the inner surface of the hole of the ferrule, the curvature of the optical fiber increases, and bending loss in the optical fiber may increase.

Therefore, an object of the present disclosure is to provide an optical fiber bundle, an optical connection structure, and a method for manufacturing an optical fiber bundle that can reduce bending loss in an optical fiber.

### Description of Embodiments of Present Disclosure

First, contents of embodiments of the present disclosure will be listed and described.

[1] An optical fiber bundle according to an aspect of the present disclosure is an optical fiber bundle for optically coupling a plurality of optical fibers to a multicore optical fiber. The optical fiber bundle includes a ferrule, a holding portion, and a plurality of optical fibers. The ferrule extends along a first direction. The ferrule has a front end in the first direction, a rear end opposite to the front end in the first direction, and a first fiber accommodating hole. The first fiber accommodating hole is a hole including a first portion located at the front end, a second portion located at the rear end, and an inner diameter transition portion connecting the first portion and the second portion to each other. The second portion has a larger inner diameter than an inner diameter of the first portion. The holding portion has a second fiber accommodating hole extending along the first direction. The second fiber accommodating hole communicates with the first fiber accommodating hole at the rear end of the ferrule. A plurality of optical fibers each have a glass fiber and a coating portion. The glass fiber includes a first diameter portion, a second diameter portion having a larger diameter than a diameter of the first diameter portion, and a tapered portion connecting the first diameter portion and the second diameter portion. At least the first diameter portion, the tapered portion, and the second diameter portion extend along the first direction. The coating portion is formed by covering a portion of the glass fiber continuous with the second diameter portion with a coating. The first diameter portion of each of the plurality of optical fibers is inserted into the first portion of the first fiber accommodating hole. The tapered portion of each of the plurality of optical fibers is inserted into the second portion of the first fiber accommodating hole. A boundary between the second diameter portion of each of the plurality of optical fibers and the coating portion of each of the plurality of optical fibers is inserted into the second fiber accommodating hole. The coating portion of each of the plurality of optical fibers includes a first portion led out from the second fiber accommodating hole and a second portion away from the second fiber accommodating hole. The coating of the first portion of each of the plurality of optical fibers is fixed to the coating of the first portion of the coating portion of at least one optical fiber among the other optical fibers. An arrangement order of the coating portions of the plurality of optical fibers in the second fiber accommodating hole is the same as an arrangement order of the first diameter portions of the plurality of optical fibers at the front end of the ferrule.

In this optical fiber bundle, the coating of the first portion of the coating portion of each of the plurality of optical fibers is fixed to the coating of the first portion of the coating portion of at least one optical fiber among the other optical fibers. According to such a configuration, in the first fiber accommodating hole and the second fiber accommodating hole, the positions of the plurality of optical fibers are prevented from being deviated from each other along the first direction. Thereby, the insertion amount of the optical fiber into the ferrule is suppressed from becoming excessive. As a result, an increase in the curvature of the optical fiber is suppressed. In addition, an arrangement order of the coating portions of the plurality of optical fibers in the second fiber accommodating hole is the same as an arrangement order of the first diameter portions of the plurality of optical fibers at the front end of the ferrule. According to such a configuration, crossing of the plurality of optical fibers inside the ferrule is suppressed. As described above, bending loss in the plurality of optical fibers can be reduced.

[2] In the optical fiber bundle of [1], the first portions of the coating portions of the plurality of optical fibers may be integrated by the coatings being fixed to each other. In the second portions of the coating portions of the plurality of optical fibers, the coatings may be separated from each other. As described above, by integrating the first portions of the coating portions, the portions of the plurality of optical fibers in the first fiber accommodating hole and the second fiber accommodating hole are further prevented from being deviated from each other. As a result, an increase in the curvature of the optical fiber is further suppressed.

[3] In the optical fiber bundle of [1], the first portions of the coating portions of the plurality of optical fibers may be two-dimensionally arranged in a cross-section intersecting a central axis of the plurality of optical fibers. The coating of the second portion of the coating portion of each of the plurality of optical fibers may be fixed to the coating of the second portion of the coating portion of at least one optical fiber among the other adjacent optical fibers. As described above, by two-dimensionally arranging the first portions of the coating portions, it is easy to optically couple the plurality of optical fibers to the plurality of cores of the multicore optical fiber.

[4] In the optical fiber bundle of [1], the coating portion of each of the plurality of optical fibers may further include a connecting portion connecting the first portion and the second portion to each other. The coatings of the first portions of the coating portions of the plurality of optical fibers may be fixed to each other such that the first portions of the coating portions of the plurality of optical fibers are two-dimensionally arranged in a cross-section intersecting a central axis of the plurality of optical fibers. The coatings of the second portions of the coating portions of the plurality of optical fibers may be fixed to each other such that the second portions of the coating portions of the plurality of optical fibers are one-dimensionally arranged in the cross-section intersecting the central axis of the plurality of optical fibers. As described above, by two-dimensionally arranging the first portions of the coating portions, it is easy to optically couple the plurality of optical fibers to the plurality of cores of the multicore optical fiber. In addition, since the second portions of the coating portions are one-dimensionally arranged, the plurality of optical fibers are prevented from being scattered and entangled with each other. As a result, when measurement or the like using the optical fiber bundle is executed, workability of the measurement or the like can be improved.

[5] The optical fiber bundle of [4] may further include a protective member protecting at least a boundary between the connecting portion and the second portion of the coating portion of each of the plurality of optical fibers. In this case, unintentional separation of the coatings of the second portions of the plurality of optical fibers is suppressed.

[6] In the optical fiber bundle of [4] or [5], the second portions of the coating portions of the plurality of optical fibers may constitute one optical fiber ribbon. In this case, the plurality of optical fibers are further prevented from being scattered and entangled with each other.

[7] In the optical fiber bundle of [6], the optical fiber ribbon may have an other coating collectively surrounding the coatings of the second portions of the coating portions of the plurality of optical fibers. An average thickness of the other coating may be 0.01 mm or more and 0.25 mm or less. According to such a configuration, since the thickness of the other coating is 0.01 mm or more, separation of the coatings of the second portions constituting the optical fiber ribbon from each other is suppressed by a sufficient strength of the other coating. In addition, since the thickness of the other coating is 0.25 mm or less, it is easy to remove the other coating when the first portion of the coating portion is formed.

[8] In the optical fiber bundle of any one of [1] to [7], fixation between the coatings of the first portions of the coating portions of the plurality of optical fibers may be fixation with an adhesive. In this case, the coatings can be easily fixed to each other.

[9] The optical fiber bundle of any one of [1] to [7] may further include a cylindrical body extending along the first direction. The first portion of the coating portion of each of the plurality of optical fibers may be inserted into the inside of the cylindrical body, and the coating of the first portion of the coating portion may be fixed to the cylindrical body with an adhesive. In this case, the coatings of the first portions of the coating portions of the plurality of optical fibers can be firmly fixed to each other.

[10] The optical fiber bundle of any one of [1] to [7] may further include a tubular shrink tube extending along the first direction. The first portions of the coating portions of the plurality of optical fibers may be housed and collectively held in the tubular shrink tube. In this case, the coatings of the first portions of the coating portions of the plurality of optical fibers can be firmly fixed to each other.

[11] In the optical fiber bundle of any one of [1] to [10], an appearance of the coating of each of the plurality of optical fibers may include a different color or hue for each optical fiber. In this case, the plurality of optical fibers can be easily discriminated.

[12] In the optical fiber bundle of any one of [1] to [11], positional deviation between the tapered portions of the plurality of optical fibers along the first direction may be 1 mm or less. In this case, an increase in the insertion amount of the optical fiber into the ferrule can be suppressed. As a result, an increase in the curvature of the optical fiber is suppressed. As a result, bending loss in the optical fiber can be reduced.

[13] An optical connection structure according to an aspect of the present disclosure may include: a first optical connector having a multicore optical fiber including a plurality of cores extending in the first direction and a cladding covering the plurality of cores, and a ferrule holding a tip of the multicore optical fiber; and a second optical connector as an optical connector having the optical fiber bundle of any one of [1] to [12]. When the second optical connector is connected to the first optical connector, each core of the plurality of optical fibers may be optically coupled to each of the plurality of cores of the multicore optical fiber. In this optical connection structure, bending loss in the plurality of optical fibers can be reduced.

[14] A method for manufacturing an optical fiber bundle according to an aspect of the present disclosure is a method for manufacturing an optical fiber bundle for optically coupling a plurality of optical fibers to a multicore optical fiber, the method including preparing a ferrule, preparing a holding portion, preparing a plurality of optical fibers, inserting the plurality of optical fibers, and fixing the plurality of optical fibers. The ferrule extends along a first direction. In the preparing the ferrule, the ferrule has a front end in the first direction, a rear end opposite to the front end in the first direction, and a first fiber accommodating hole. The first fiber accommodating hole is a hole including a first portion located at the front end, a second portion located at the rear end and having a larger inner diameter than an inner diameter of the first portion, and an inner diameter transition portion connecting the first portion and the second portion to each other. In the preparing the holding portion, the holding portion has a second fiber accommodating hole as a hole extending along the first direction and communicating with the first fiber accommodating hole at the rear end of the ferrule. In the preparing the plurality of optical fibers, the plurality of optical fibers each have a glass fiber and a coating portion. The glass fiber includes a first diameter portion, a second diameter portion having a larger diameter than a diameter of the first diameter portion, and a tapered portion connecting the first diameter portion and the second diameter portion. At least the first diameter portion, the tapered portion, and the second diameter portion extend along the first direction. The coating portion is formed by covering a portion of the glass fiber continuous with the second diameter portion with a coating. In the inserting of the plurality of optical fibers, the first diameter portion of each of the plurality of optical fibers, the tapered portion of each of the plurality of optical fibers, and a boundary between the second diameter portion of each of the plurality of optical fibers and the coating portion of each of the plurality of optical fibers are inserted into the first portion of the first fiber accommodating hole, the second portion of the first fiber accommodating hole, and the second fiber accommodating hole, respectively. In the fixing the plurality of optical fibers, the plurality of optical fibers are fixed to the ferrule with an adhesive. In the preparing the plurality of optical fibers, the coating portion of each of the plurality of optical fibers includes a first portion led out from the second fiber accommodating hole and a second portion away from the second fiber accommodating hole. The coating of the first portion of each of the plurality of optical fibers is fixed to the coating of the first portion of the coating portion of at least one optical fiber among the other optical fibers. In the fixing the plurality of optical fibers, an arrangement order of the coating portions of the plurality of optical fibers in the second fiber accommodating hole is the same as an arrangement order of the first diameter portions of the plurality of optical fibers at the front end of the ferrule.

In this method for manufacturing an optical fiber bundle, the coating of the first portion of the coating portion of each of the plurality of optical fibers is fixed to the coating of the first portion of the coating portion of at least one optical fiber among the other plurality of optical fibers. According to such a configuration, in the first fiber accommodating hole and the second fiber accommodating hole, the positions of the plurality of optical fibers are prevented from being deviated from each other along the first direction. Thereby, the insertion amount of the optical fiber into the ferrule is suppressed from becoming excessive. As a result, an increase in the curvature of the optical fiber is suppressed. In addition, an arrangement order of the coating portions of the plurality of optical fibers in the second fiber accommodating hole is the same as an arrangement order of the first diameter portions of the plurality of optical fibers at the front end of the ferrule. According to such a configuration, crossing of the plurality of optical fibers inside the ferrule is suppressed. As described above, it is possible to manufacture an optical fiber bundle in which bending loss of a plurality of optical fibers are reduced.

[15] In the inserting of the plurality of optical fibers of the method for manufacturing an optical fiber bundle of [14], the coating portions of the plurality of optical fibers may be disposed on a jig to align and temporarily fix the plurality of optical fibers in a predetermined arrangement, and the jig may be removed from the plurality of optical fibers after the plurality of optical fibers are inserted into the ferrule. In this case, since the plurality of coating portions are prevented from being scattered and entangled with each other, workability of the inserting is improved.

[16] In the method for manufacturing an optical fiber bundle of [14] or [15], the preparing of the plurality of optical fibers may include forming the first diameter portion and the tapered portion by separating the plurality of optical fibers from each other over a length of 10 mm or more from a tip of an optical fiber ribbon formed by integrating the plurality of optical fibers and chemically etching a tip of the glass fiber of each of the optical fibers. In this case, the first diameter portions and the tapered portions of the plurality of optical fibers can be easily formed.

### Details of Embodiments of Present Disclosure

Specific examples of the optical fiber bundle, the optical connection structure, and the method for manufacturing an optical fiber bundle according to the present embodiment will be described with reference to the drawings as necessary. It should be noted that the present invention is not limited to these examples, is described by the claims, and is intended to include meanings equivalent to the claims and all changes within the scope of the claims. In the following description, the same elements are denoted by the same reference numerals in the description of the drawings, and redundant description will be omitted.

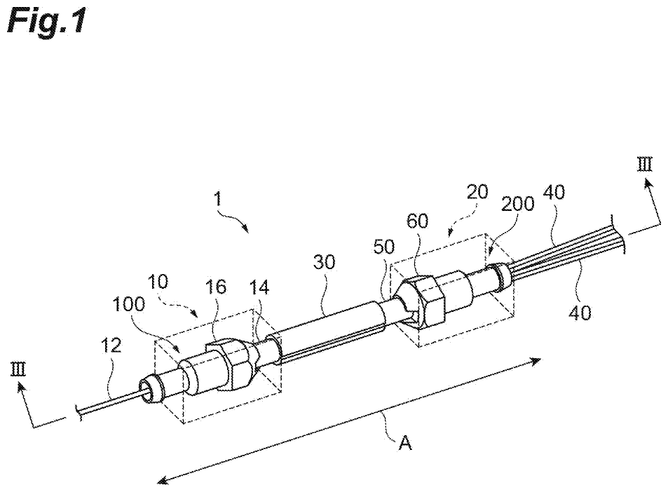

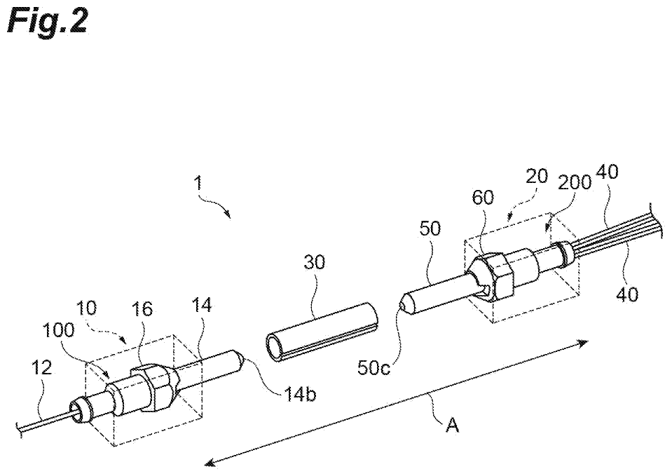

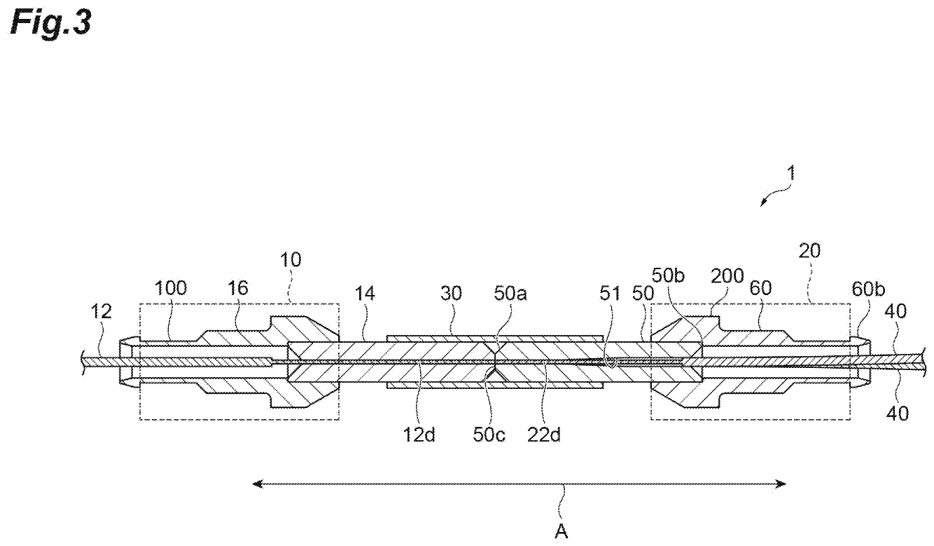

FIG. 1 is a perspective view illustrating an optical connection structure according to an embodiment. FIG. 2 is an exploded perspective view of the optical connection structure illustrated in FIG. 1. FIG. 3 is a cross-sectional view of the optical connection structure illustrated in FIG. 1 along the line III-III. As illustrated in FIGS. 1 to 3, an optical connection structure 1 includes a first optical connector 10, a second optical connector 20, and a split sleeve 30 (sleeve).

The first optical connector 10 includes a structure 100 having a multicore fiber 12 (hereinafter, also referred to as “MCF 12”), a ferrule 14, and a flange 16. The second optical connector 20 includes an optical fiber bundle 200 having a plurality of optical fibers 40, a ferrule 50, and a flange 60 (holding portion). The optical fiber bundle 200 is configured to optically couple the plurality of optical fibers 40 to the MCF 12. When the first optical connector 10 is connected to the second optical connector 20, each core of the plurality of optical fibers 40 is optically coupled to each of the plurality of cores of the MCF 12. The split sleeve 30 is a member that holds and align the ferrule 14 and the ferrule 50 from the outside so that a central axis of the ferrule 14 of the first optical connector 10 coincides with a central axis of the ferrule 50.

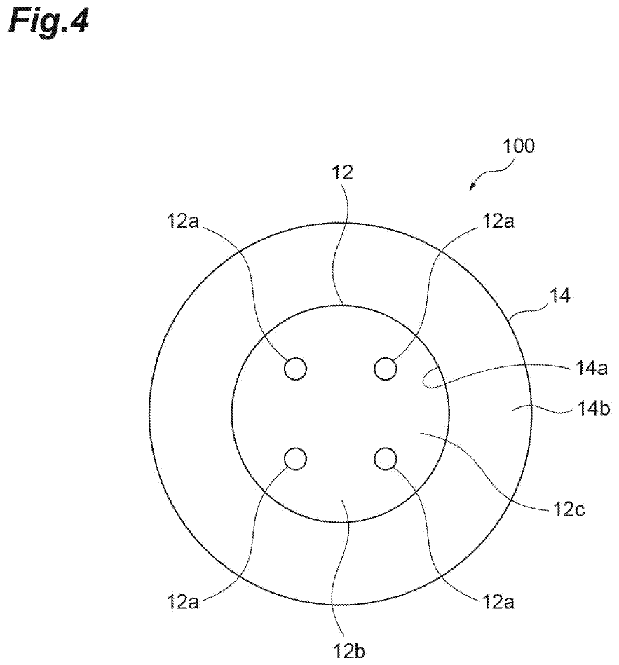

FIG. 4 is a view schematically illustrating a tip of the MCF 12 and an end surface of the ferrule 14. As illustrated in FIG. 4, the MCF 12 has a plurality of cores 12a, a cladding 12b, and a tip surface 12c. The plurality of cores 12a extend along a longitudinal direction A (see FIGS. 1 to 3). The cladding 12b extends along the longitudinal direction A and collectively covers the plurality of cores 12a. The tip surface 12c is configured by tips of the plurality of cores 12a and a tip of the cladding 12b. The core 12a mainly contains silica glass doped with a dopant such as germanium to increase a refractive index. The cladding 12b mainly contains silica glass doped with a dopant such as fluorine to lower a refractive index. The composition of the core 12a and the cladding 12b and the combination of dopants can be appropriately selected. In such an MCF 12, each core 12a can propagate an optical signal for each core 12a.

In a cross-section perpendicular to the central axis of the MCF 12, the plurality of cores 12a are, for example, two-dimensionally arranged. In the present embodiment, the MCF 12 has four cores 12a. The MCF 12 may have seven cores 12a. The MCF 12 may have eight cores 12a. The MCF 12 may have nineteen cores 12a. The number of cores 12a of the MCF 12 is not limited thereto. In an example illustrated in FIG. 4, four cores 12a are arranged in a square lattice pattern of 2 rows and 2 columns. The diameter (core diameter) of each core 12a may be, for example, 10 μm or less. The diameter (core diameter) of each core 12a may be, for example, 5 μm or less. The diameter (core diameter) of each core 12a may be, for example, 1 μm or more. The core pitch (distance between centers) between the adjacent cores 12a may be, for example, 10 μm or more and 50 μm or less. The diameter (cladding diameter) of the cladding 12b may be, for example, 200 μm or less. The diameter (cladding diameter) of the cladding 12b may be, for example, 125 μm or less. The diameter (cladding diameter) of the cladding 12b may be, for example, 100 μm or less. The diameter (cladding diameter) of the cladding 12b may be, for example, 80 μm or less. The diameter (cladding diameter) of the cladding 12b may be 50 μm or more.

The ferrule 14 is a cylindrical member holding a tip portion 12d (see FIG. 3) of the MCF 12. The ferrule 14 has an inner hole 14a and an end surface 14b. The inner hole 14a is a through hole accommodating the tip portion 12d of the MCF 12. The ferrule 14 fixes the tip portion 12d of the MCF 12 to the inner hole 14a such that the tip surface 12c of the MCF 12 is exposed at the end surface 14b. The inner diameter of the inner hole 14a is the same as or slightly larger than the outer diameter of the MCF 12, and the tip portion 12d of the MCF 12 is fitted into the inner hole 14a by being inserted into the inner hole 14a. The ferrule 14 has a length of, for example, 6 mm or more and 8 mm or less. The ferrule 14 is made of, for example, a ceramic material such as zirconia.

As illustrated in FIG. 3, the flange 16 holds a rear end portion of the ferrule 14. The flange 16 is a tubular member accommodating the MCF 12 thereinside. A portion of the MCF 12 accommodated in the flange 16 may be fixed inside the flange 16 by an adhesive. The flange 16 is made of, for example, a metal or a resin.

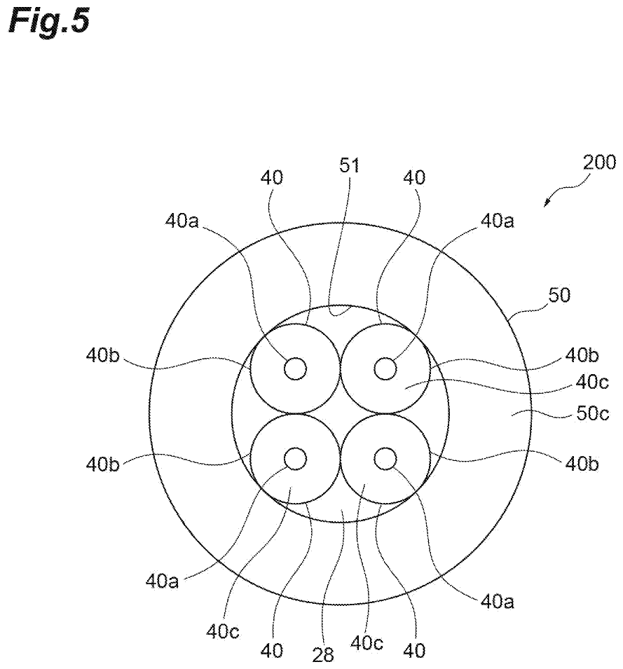

The plurality of optical fibers 40 are optical fibers optically coupled to the MCF 12. FIG. 5 is a view illustrating the tips of the plurality of optical fibers 40 and an end surface of the ferrule 50. As illustrated in FIG. 5, each optical fiber 40 has a core 40a and a cladding 40b. The core 40a extends in the longitudinal direction A (see FIGS. 1 to 3). The cladding 40b extends in the longitudinal direction A and covers the core 40a. Each optical fiber 40 has a tip surface 40c. The tip surface 40c is configured by a tip of the core 40a and a tip of the cladding 40b. The core 40a mainly contains silica glass doped with a dopant such as germanium to increase a refractive index. The cladding 40b mainly contains silica glass doped with a dopant such as fluorine to lower a refractive index. The composition of the core 40a and the cladding 40b and the combination of dopants can be appropriately selected. In such an optical fiber 40, each core 40a propagates an optical signal.

The optical fiber 40 is, for example, a single mode fiber. In this case, a refractive index distribution in a radial direction of the optical fiber 40 is a trench type. As a result, the optical loss when the optical fiber 40 is bent can be reduced as compared with a case where the refractive index distribution is a monomodal type. The optical loss when light having a wavelength of 1.55 μm passes through the optical fiber 40 may be 0.15 dB or less. The optical loss when light having a wavelength of 1.625 μm passes through the optical fiber 40 may be 0.45 dB or less. The refractive index distribution in the radial direction of the optical fiber 40 may be a monomodal type.

The plurality of optical fibers 40 are two-dimensionally arranged in a cross-section orthogonal to the longitudinal direction A. In an example illustrated in FIG. 5, four optical fibers 40 are arranged in a square lattice pattern of 2 rows and 2 columns. In the present embodiment, the second optical connector 20 has four optical fibers 40. The second optical connector 20 may have seven optical fibers 40. The second optical connector 20 may have eight optical fibers 40. The second optical connector 20 may have nineteen optical fibers 40. The number of optical fibers of the second optical connector 20 is not limited to the above. The number and arrangement of the plurality of optical fibers 40 of the second optical connector 20 correspond to the number and arrangement of the plurality of cores 12a of the MCF 12 of the first optical connector 10 on a one-to-one basis. In other words, the arrangement of the plurality of optical fibers 40 coincides with the arrangement of the plurality of cores 12a of the MCF 12. However, the number and arrangement of the plurality of optical fibers 40 do not need to completely coincide with the number and arrangement of the plurality of cores 12a of the MCF 12. For example, at least one of the plurality of optical fibers 40 may be configured not to be optically connected to the core 12a. For example, at least one of the plurality of cores 12a may be configured not to be optically connected to the optical fiber 40. The plurality of optical fibers 40 are optically coupled to each core 12a of the MCF 12 of the first optical connector 10 by rotational adjustment around a central axis of the ferrule 50.

The diameter (core diameter) of each core 40a may be, for example, 10 μm or less. The diameter (core diameter) of each core 40a may be 5 μm or less. The diameter (core diameter) of each core 40a may be, for example, 1 μm or more. The core pitch (distance between centers) between the adjacent cores 40a may be, for example, 10 μm or more and 50 μm or less. The diameter (cladding diameter) of the cladding 40b may be 80 μm or more and 125 μm or less outside the ferrule 50 described below. The diameter (cladding diameter) of the cladding 40b is smaller inside the ferrule 50 than outside the ferrule 50. The circumscribed circle of the bundle of a plurality of claddings 40b reduced in diameter coincides with the cladding diameter of the MCF 12.

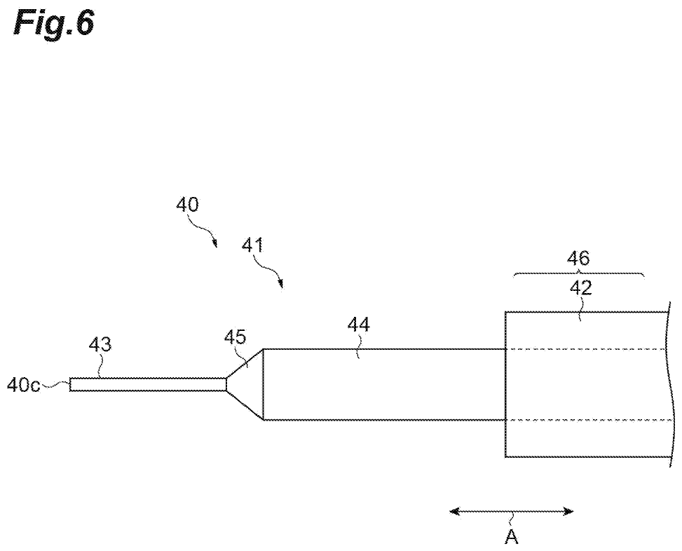

The outer diameter of the cladding 40b is narrower inside the ferrule 50 than the outer diameter outside the ferrule 50. Such an optical fiber can be realized by etching the tip portion with hydrofluoric acid liquid or the like. FIG. 6 is a schematic view illustrating the optical fiber 40 viewed from a direction intersecting the longitudinal direction A. Each optical fiber 40 has a glass fiber 41 made of glass and a coating 42 made of a resin. The glass fiber 41 includes a first diameter portion 43, a second diameter portion 44, and a tapered portion 45. The tapered portion 45 connects the first diameter portion 43 and the second diameter portion 44 to each other. A portion of the glass fiber 41 continuous with the second diameter portion 44 is covered with the coating 42 while being covered therearound. The portion of the glass fiber 41 continuous with the second diameter portion 44 and the coating 42 constitute a coating portion 46. An organic resin material is usually used for the coating 42. For example, an ultraviolet curable resin or a thermosetting resin is used for the coating 42.

The first diameter portion 43 includes the tip surface 40c. The first diameter portion 43 extends from the tip surface 40c along the longitudinal direction A. The diameter of the first diameter portion 43 is, for example, 40 μm. The tapered portion 45 is continuous with the first diameter portion 43 and extends along the longitudinal direction A. The length of the tapered portion 45 in the longitudinal direction A is, for example, 0.1 mm or more and 0.5 mm or less. The diameter of the tapered portion 45 increases from the first diameter portion 43 toward the second diameter portion 44. The second diameter portion 44 is continuous with the tapered portion 45 and extends along the longitudinal direction A. In other words, the tapered portion 45 is located between the first diameter portion 43 and the second diameter portion 44 in the longitudinal direction A. The second diameter portion 44 has a diameter larger than that of the first diameter portion 43. The diameter of the second diameter portion 44 is, for example, 80 μm or more and 125 μm or less. The coating 42 covers the periphery of the glass fiber 41 in the coating portion 46. Positional deviation between the tapered portions 45 of the plurality of optical fibers 40 along the longitudinal direction A may be 1 mm or less.

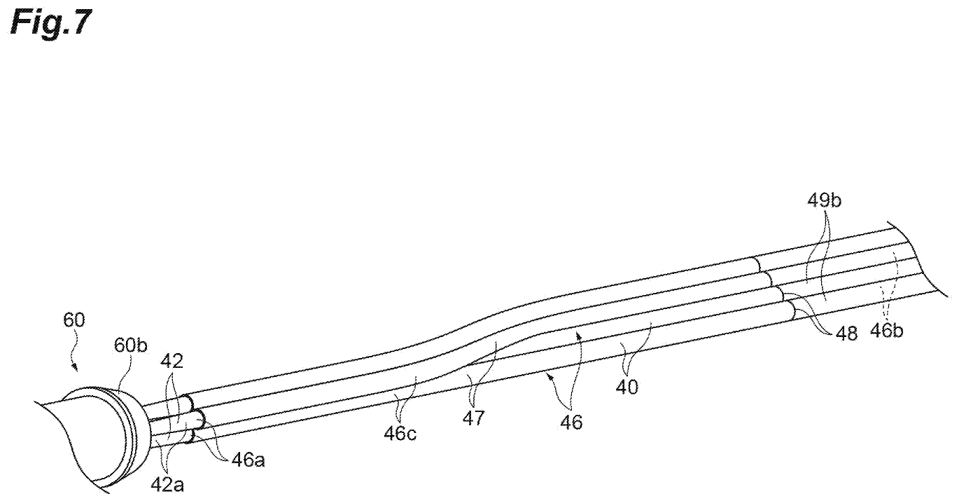

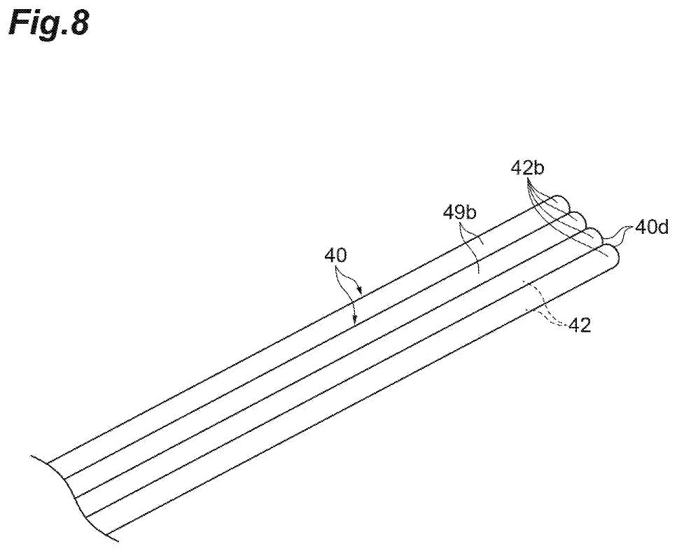

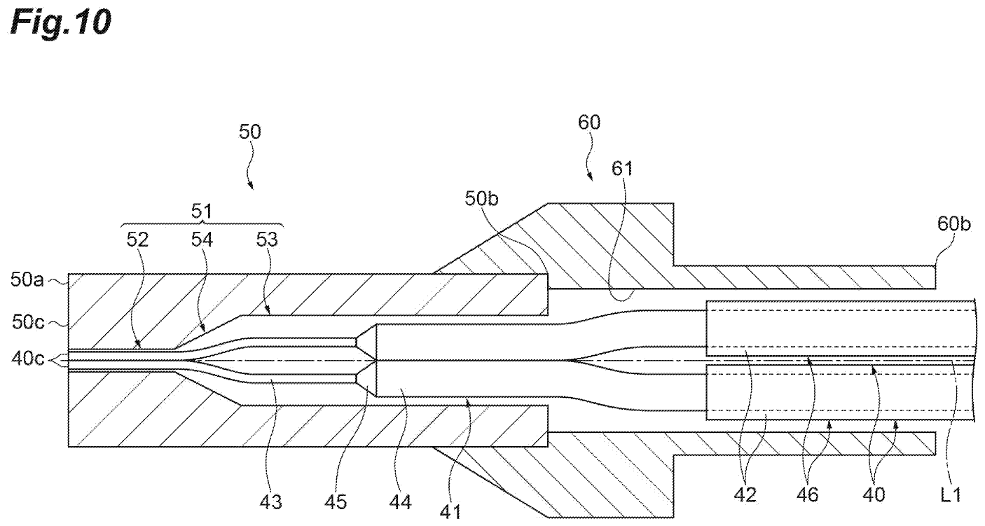

FIGS. 7 and 8 are perspective views illustrating the plurality of optical fibers 40 outside the ferrule 50 and the flange 60. As illustrated in FIG. 7, the plurality of optical fibers 40 extend from a rear end 60b of the flange 60 to the rear side of the flange 60. The coating portion 46 has a first portion 46a, a second portion 46b, and a connecting portion 46c. The first portion 46a is continuous with the second diameter portion 44 and is led out from an inner hole 61 (see FIG. 10). The second portion 46b is separated from the inner hole 61. The connecting portion 46c couples the first portion 46a to the second portion 46b. The first portions 46a are two-dimensionally arranged in a cross-section intersecting a central axis of the plurality of optical fibers 40. The second portions 46b are arranged one-dimensionally (in a line) in the cross-section intersecting the central axis of the plurality of optical fibers 40.

Each of the plurality of connecting portions 46c includes an arrangement changing portion 47. The plurality of optical fibers 40 is changed from a two-dimensional array to a one-dimensional arrangement in the arrangement changing portion 47 separated from the rear end 60b of the flange 60 by a certain distance. A portion of the plurality of optical fibers 40 behind the arrangement changing portion 47 (that is, the second portion 46b) constitutes a four-core optical fiber ribbon. The optical fiber ribbon has a second coating 49b. The second coating 49b collectively surrounds the coating 42 of the second portion 46b of each of the plurality of optical fibers 40. The average thickness of the second coating 49b is, for example, 0.01 mm or more and 0.25 mm or less. The plurality of optical fibers 40 are separated into two two-core optical fiber ribbons by tearing the second coating 49b at a boundary 48 between the connecting portion 46c and the second portion 46b. The plurality of optical fibers 40 are further single-core separated by removing the second coating 49b in the first portion 46a in front of the connecting portion 46c. The first portions 46a of the plurality of optical fibers 40 are aligned in a two-dimensional array near the flange 60. The coatings 42 of the first portions 46a are fixed to each other near the flange 60. In an example illustrated in FIG. 7, the plurality of first portions 46a single-core separated and aligned in a two-dimensional array are inserted into the inner hole 61 of the flange 60 (see FIG. 3).

A protective member collectively protecting the plurality of boundaries 48 may be provided at the boundaries 48 in the plurality of optical fibers 40. The protective member may collectively protect the plurality of connecting portions 46c and the plurality of boundaries 48. The protective member may collectively protect the plurality of second portions 46b, the plurality of connecting portions 46c, and the plurality of boundaries 48. The protective member may collectively protect the plurality of first portions 46a, the plurality of second portions 46b, the plurality of connecting portions 46c, and the plurality of boundaries 48.

FIG. 8 illustrates the vicinity of a terminal end of the plurality of optical fibers 40. As illustrated in FIG. 8, each of the plurality of optical fibers 40 further includes a terminal end surface 40d opposite to the tip surface 40c. In an example illustrated in FIG. 8, four terminal end surfaces 40d are arranged one-dimensionally (in a line).

The coating 42 of each of the plurality of optical fibers 40 includes a tip portion 42a (see FIG. 7) and a terminal end portion 42b (see FIG. 8). The tip portion 42a is adjacent to the second diameter portion 44. The terminal end portion 42b is located on a side opposite to the tip portion 42a. The tip portion 42a constitutes an outer peripheral portion of the tip of the first portion 46a. The terminal end portion 42b constitutes an outer peripheral portion of the tip of the second portion 46b. The coating 42 of each optical fiber 40 is fixed to the coating 42 of at least one optical fiber 40 among the other optical fibers 40. The tip portions 42a are fixed to each other. The terminal end portions 42b are fixed to each other, so that the plurality of second portions 46b constitute an optical fiber ribbon. Fixation between the tip portions 42a is fixation with an adhesive. Fixation between the terminal end portions 42b may be fixation with an adhesive. Fixation between the terminal end portions 42b may be fixation with the second coating 49b.

In the illustrated example, the coatings 42 of the connecting portions 46c of two upper optical fibers 40 of four optical fibers 40 are further covered with the second coatings 49b to be fixed to each other, whereby the two optical fibers 40 are formed into an optical fiber ribbon (integrated). The coatings 42 of the connecting portions 46c of two lower optical fibers 40 of four optical fibers 40 are further covered with the second coatings 49b to be fixed to each other, whereby the two optical fibers 40 are formed into an optical fiber ribbon (integrated). The coatings 42 of the second portions 46b of four optical fibers 40 are further covered with the second coatings 49b to be fixed to the coatings 42 of the second portions 46b of other adjacent optical fibers 40. As a result, in the second portions 46b of the plurality of optical fibers 40, all of the plurality of optical fibers 40 are formed into an optical fiber ribbon (integrated) up to the vicinity of the terminal end.

The coating 42 includes a different appearance for each optical fiber 40. Specifically, in each of the plurality of optical fibers 40, the appearance of the tip portion 42a of the coating 42 and the appearance of the terminal end portion 42b of the coating 42 each include color or hue. In each of the plurality of optical fibers 40, the color or hue of the tip portion 42a and the color or hue of the terminal end portion 42b correspond to each other (for example, coincide with each other). The color or hue of the coating 42 is different for each optical fiber 40. As an example, the coatings 42 of four optical fibers 40 each include gray, pink, green, and orange. The coating 42 may not be formed from a single material. The coatings 42 may be formed so as to form a plurality of concentric layers around the central axis of the optical fiber 40 in the cross-section orthogonal to the longitudinal direction of the optical fiber 40. The color or hue of the coating 42 located in the outermost layer in each optical fiber 40 may be different for each optical fiber 40.

As illustrated in FIG. 3, the ferrule 50 extends along the longitudinal direction A. The ferrule 50 is, for example, a cylindrical member made of ceramic such as zirconia, glass, or metal. The ferrule 50 collectively holds the tip portions of the plurality of optical fibers 40. The ferrule 50 has a front end 50a, a rear end 50b, an end surface 50c, and an inner hole 51 (first fiber accommodating hole). The front end 50a is a front end in the longitudinal direction A. The rear end 50b is located on a side opposite to the front end 50a in the longitudinal direction A. The end surface 50c is located at the front end 50a. The inner hole 51 is a through hole reaching the front end 50a from the rear end 50b, and accommodates the plurality of optical fibers 40 as illustrated in FIG. 5.

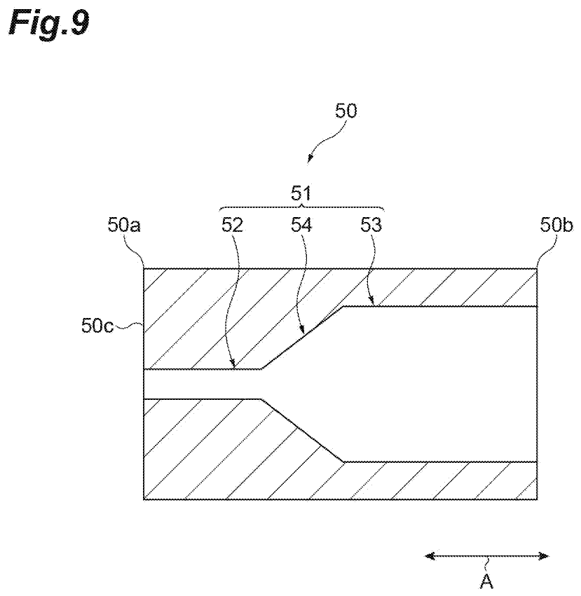

FIG. 9 is a cross-sectional view schematically illustrating the inner hole 51. The inner hole 51 includes a first portion 52, a second portion 53, and an inner diameter transition portion 54. The first portion 52 is located at the front end 50a. The second portion 53 is located at the rear end 50b. The inner diameter transition portion 54 connects the first portion 52 and the second portion 53 to each other. The first portion 52 extends from the front end 50a along the longitudinal direction A. The inner diameter of the first portion 52 is smaller than the inner diameter of the second portion 53. The inner diameter of the first portion 52 is the same as or slightly larger than the diameter of the circumscribed circle of the bundle of the first diameter portions 43 of the plurality of optical fibers 40. The inner diameter of the first portion 52 is, for example, 90 μm or more and 100 μm or less. The inner diameter transition portion 54 is continuous from the first portion 52 and extends along the longitudinal direction A. The inner diameter of the inner diameter transition portion 54 coincides with the inner diameter of the first portion 52 at the boundary with the first portion 52. The inner diameter of the inner diameter transition portion 54 increases from the first portion 52 toward the second portion 53, and coincides with the inner diameter of the second portion 53 at the boundary with the second portion 53. The inner diameter transition portion 54 may have a tapered shape. The inner diameter transition portion 54 may have a curvature in the cross-section. The second portion 53 is continuous from the inner diameter transition portion 54 and extends along the longitudinal direction A. In other words, in the longitudinal direction A, the inner diameter transition portion 54 is located between the first portion 52 and the second portion 53. The inner diameter of the second portion 53 is, for example, 300 μm or more and 400 μm or less.

FIG. 10 is a schematic cross-sectional view illustrating the plurality of optical fibers 40 inserted into the inner hole 51 of the ferrule 50 and the inner hole 61 (described below) of the flange 60. The ferrule 50 holds the first diameter portion 43, the tapered portion 45, and the second diameter portion 44. A part of the first diameter portion 43 of each of the plurality of optical fibers 40 is inserted into the first portion 52 and the inner diameter transition portion 54 of the inner hole 51. The rest of the first diameter portion 43 of the plurality of optical fibers 40, the tapered portion 45, and a part of the second diameter portion 44 are inserted into the second portion 53 of the inner hole 51.

The plurality of optical fibers 40 are fixed to the ferrule 50 with an adhesive. Specifically, the first diameter portion 43. the tapered portion 45, and the second diameter portion 44 are fixed to the inner hole 51 with an adhesive 28 (see FIG. 5) such that each tip surface 40c of the plurality of optical fibers 40 is exposed at the end surface 50c of the ferrule 50. The first diameter portion 43, the tapered portion 45, and the second diameter portion 44 are bonded and fixed to each other with the adhesive 28 injected into a gap with the inner hole 51. The adhesive 28 is, for example, a thermosetting epoxy-based adhesive. After the adhesive 28 is injected into a predetermined place, the adhesive 28 can be cured by heating. The length of the ferrule 50 in the longitudinal direction A is, for example, 6 mm or more and 8 mm or less. In a case where the ferrule 50 is made of glass, the adhesive 28 may be an ultraviolet curable epoxy-based adhesive or an ultraviolet curable acryl-based adhesive.

As illustrated in FIG. 10, the flange 60 holds a rear end portion of the ferrule 50. The flange 60 is a tubular member accommodating the plurality of optical fibers 40 thereinside. The flange 60 has the inner hole 61 (second fiber accommodating hole). The inner hole 61 is a through hole extending along the longitudinal direction A. The inner hole 61 communicates with the inner hole 51 at the rear end 50b of the ferrule 50. The inner hole 51 and the inner hole 61 has the same central axis L1. A boundary between the second diameter portion 44 of each of the plurality of optical fibers 40 and the coating portion 46 is inserted into the inner hole 61. That is, the rest of the second diameter portion 44 and a part of the coating portion 46 are inserted into the inner hole 61. The coatings 42 of the portion of the second diameter portion 44 accommodated in the inner hole 61 and the coatings 42 of the portion of the coating portion 46 accommodated in the inner hole 61 may be fixed in the flange 60 with an adhesive. The flange 60 is made of, for example, glass, a metal, or a resin. In a case where four optical fibers 40 each having the coating 42 having an outer diameter of 250 μm are bundled and inserted into the inner hole 61, the diameter of the circumscribed circle of the bundle is 604 μm. In this case, the inner diameter of the inner hole 61 is 604 μm or more.

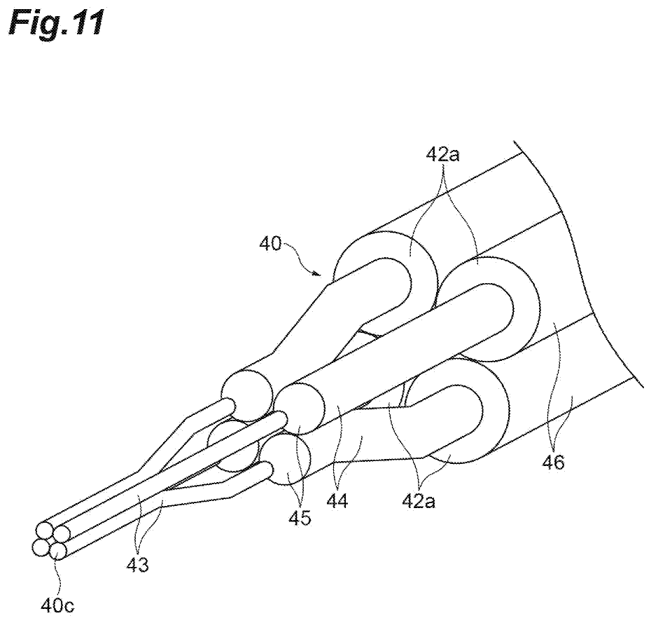

FIG. 11 is a perspective view illustrating a form of the plurality of optical fibers 40 in the inner hole 51 and the inner hole 61. An arrangement order of the coating portions 46 in the inner hole 61 is the same as an arrangement order of the first diameter portions 43 of the plurality of optical fibers 40 at the front end 50a of the ferrule 50. That is, the first diameter portion 43 of each optical fiber 40 does not cross the first diameter portion 43 of another optical fiber 40 in the inner hole 51 of the ferrule 50. Here, crossing means that the relative positional relationship of the first diameter portions 43 of the plurality of optical fibers 40 change between one end and the other end of the first diameter portion 43 in the longitudinal direction A. The crossing means, for example, that the plurality of optical fibers 40 are intertwined like a braid. The arrangement of the tip surfaces 40c of the plurality of optical fibers 40 in the front end 50a of the ferrule 50 is not deviated in the circumferential direction about the central axes L1 of the inner holes 51 and 61 with respect to the arrangement of the coating portions 46 of the plurality of optical fibers 40 in the inner hole 61 of the flange 60. Alternatively, even if the arrangement of the tip surfaces 40c of the plurality of optical fibers 40 in the front end 50a of the ferrule 50 is deviated from the arrangement of the coating portions 46 of the plurality of optical fibers 40 in the inner hole 61 of the flange 60, the deviation is less than 90 degrees at an angle around the central axis L1. In a case where the deviation is allowed as required characteristics of products, either the crossing between the first diameter portions 43 or the deviation of 90 degrees or more may occur.

Next, a method for manufacturing the optical connection structure 1 will be described. First, the first optical connector 10 including the structure 100 is manufactured. Specifically, first, the MCF 12, the ferrule 14, and the flange 16 are prepared. In the MCF 12, each core 12a is arranged in a predetermined manner. For example, in the MCF 12, each of the cores 12a has a square arrangement of four cores 12a.

Subsequently, the MCF 12 is inserted into the inner hole of the flange 16 and the inner hole 14a of the ferrule 14, and the tip portion 12d of the MCF 12 is fitted into the inner hole 14a of the ferrule 14. At this time, the tip surface 12c of the MCF 12 may coincide with the end surface 14b of the ferrule 14. After the tip portion 12d of the MCF 12 is fitted into the inner hole 14a of the ferrule 14, the tip surface 12c of the MCF 12 may be polished together with the end surface 14b of the ferrule 14. For example, in a case where polishing is performed so as to enable PC (Physical contact) connection, the curvature radius of the end surface 14b of the ferrule 14 is, for example, 1 mm or more and 50 mm or less. The structure 100 is prepared by accommodating the ferrule 14 and the flange 16 in a housing (not illustrated). Then, the first optical connector 10 is prepared by accommodating the ferrule 14 and the flange 16 in a housing (not illustrated).

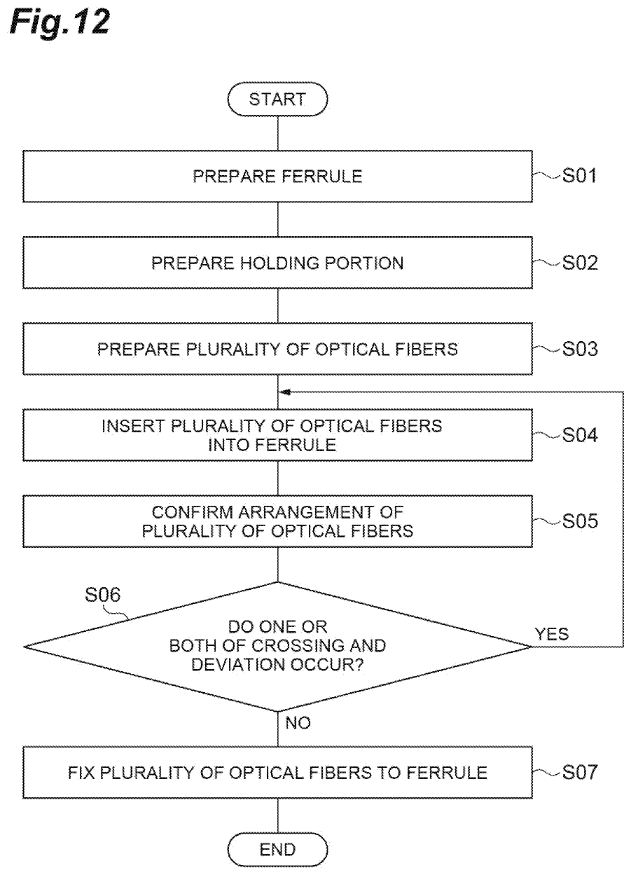

Next, the second optical connector 20 including the optical fiber bundle 200 is manufactured. Hereinafter, a method for manufacturing the optical fiber bundle 200 will be described. FIG. 12 is a flowchart illustrating a method for manufacturing the optical fiber bundle 200. First, the ferrule 50 having the front end 50a, the rear end 50b, and the inner hole 51 is prepared (Step S01: step of preparing a ferrule). Next, the flange 60 having the inner hole 61 is prepared (Step S02: step of preparing a holding portion). The preparation of the flange 60 may be performed before the preparation of the ferrule 50. The preparation of the flange 60 and the preparation of the ferrule 50 may be performed in parallel.

Subsequently, the plurality of optical fibers 40 each having the glass fiber 41 and the coating 42 are prepared (Step S03: step of preparing a plurality of optical fibers). The step of preparing the plurality of optical fibers 40 includes a step of forming the first diameter portion 43 and the tapered portion 45 by subjecting the glass fiber of the optical fiber 40 to diameter reduction process (step of forming the first diameter portion 43 and the tapered portion 45). In the step of forming the first diameter portion 43 and the tapered portion 45, the plurality of optical fibers 40 are separated from each other over a length of 10 mm or more from a tip of an optical fiber ribbon formed by integrating the plurality of optical fibers 40 and a tip of the glass fiber 41 of each of the optical fibers 40 is chemically etched. As an example, only the tip portion of the optical fiber ribbon including the plurality of optical fibers 40 is single-core separated, and the tip portion is immersed in etchant to be chemically etched. The etchant is, for example, hydrofluoric acid. As described above, by single-core separating only the tip portion of the optical fiber ribbon and keeping the portions other than the tip portion as the optical fiber ribbon, scattering and entanglement of the plurality of optical fibers 40 from the step of inserting the plurality of optical fibers 40 (Step S04) to the fixing step (Step S07) are suppressed, so that workability is improved. In the step of preparing the plurality of optical fibers 40, the coating 42 of the first portion 46a of each of the plurality of optical fibers 40 is fixed to the coating 42 of the first portion 46a of at least one (for example, all) of the optical fiber 40 among other optical fibers 40, for example, with an adhesive, in a state where the first portions 46a of the plurality of optical fibers 40 are arranged in a predetermined arrangement order corresponding to the arrangement of the plurality of cores 12a of the MCF 12. The preparation of the plurality of optical fibers 40 may be performed before the preparation of one or both of the flange 60 and the ferrule 50. The preparation of the plurality of optical fibers 40 may be performed in parallel with the preparation of one or both of the flange 60 and the ferrule 50. The step of preparing the plurality of optical fibers 40 (Step S03) may include a step of changing the appearance of the coating 42. In the changing step, the appearance of the coating 42 may be changed by applying a color to the coating 42 using a pen or the like.

Subsequently, the plurality of optical fibers 40 are inserted into the inner hole 61 of the flange 60 and the inner hole 51 of the ferrule 50 (Step S04: inserting step). In this step, the plurality of optical fibers 40 are collectively inserted into the inner hole 61 of the flange 60 and the inner hole 51 of the ferrule 50, and the plurality of optical fibers 40 are arranged in the inner hole 51 of the ferrule 50. Specifically, first, the coating portions 46 of the plurality of optical fibers 40 are disposed on a jig to align and temporarily fix the plurality of optical fibers 40 in a predetermined arrangement. Next, as illustrated in FIG. 10, the first diameter portions 43 of the plurality of optical fibers 40 are inserted into the first portion 52 of the inner hole 51 of the ferrule 50. At the same time, the tapered portions 45 of the plurality of optical fibers 40 are inserted into the second portion 53 of the inner hole 51 of the ferrule 50. At the same time, the boundary between the second diameter portion 44 of each of the plurality of optical fibers 40 and the coating portion 46 is inserted into the inner hole 61 of the flange 60. At this time, the plurality of optical fibers 40 are arranged in the ferrule 50 so as to correspond to the arrangement of the cores 12a of the MCF 12 (for example, two-dimensionally in a cross-section intersecting the longitudinal direction A). At this time, each optical fiber 40 is arranged such that the claddings 40b are in contact with each other and are also in contact with the inner hole 51 of the ferrule 50. Thereafter, the jig is removed from the plurality of optical fibers 40.

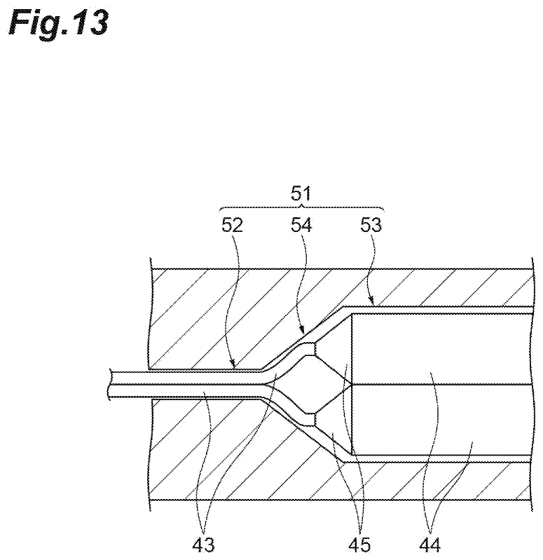

FIG. 13 is a view illustrating a state in the middle of inserting the plurality of optical fibers 40 into the ferrule 50. As illustrated in FIG. 13, when the plurality of optical fibers 40 are inserted deep into the inner hole 51 of the ferrule 50, the optical fiber 40 comes into contact with the inner diameter transition portion 54 of the ferrule 50. At this time, the optical fiber 40 cannot move toward the front end 50a of the ferrule 50 (see FIG. 10) and stops. In this state, bending of the first diameter portion 43 of the optical fiber 40 increases in the inner diameter transition portion 54, and bending loss and breakage may occur in the first diameter portion 43. Therefore, in the inserting step, as illustrated in FIG. 13, the optical fiber 40 is inserted until abutting the inner diameter transition portion 54, and then the optical fiber 40 is pulled back by a certain distance as illustrated in FIG. 10. Thereby, it is possible to insert the first diameter portion 43 into the first portion 52 while bending the first diameter portion 43 with a small curvature in the second portion 53 and the inner diameter transition portion 54 of the inner hole 51 of the ferrule 50. As a result, bending loss and breakage in the first diameter portion 43 can be suppressed.

Subsequently, the arrangement of the plurality of optical fibers 40 at the front end 50a of the ferrule 50 is confirmed (Step S05: confirming step). Specifically, by propagating light from the terminal end surface 40d of each of the plurality of optical fibers 40 and observing the tip surface 40c of each of the plurality of optical fibers 40, the arrangement of the plurality of optical fibers 40 at the front end 50a of the ferrule 50 is confirmed. That is, the correspondence relationship between the terminal end surfaces 40d and the tip surfaces 40c of the plurality of optical fibers 40 is confirmed by propagating light from the terminal end surfaces 40d of the plurality of optical fibers 40. As an example, red laser light is incident from the terminal end surface 40d of the optical fiber 40. In this case, at the front end 50a of the ferrule 50, red laser light is emitted from the core 40a of the optical fiber 40. At this time, the tip surfaces 40c of the plurality of optical fibers 40 are enlarged and observed with a microscope or the like to record the position where the red laser light is emitted. As a result, the correspondence relationship between the terminal end surfaces 40d and the tip surfaces 40c of the plurality of optical fibers 40 can be confirmed. The light incident on the optical fiber 40 may be visible light.

Subsequently, it is determined whether one or both of crossing and deviation occur (Step S06: determining step). The crossing is crossing between the first diameter portion 43 of one optical fiber 40 among the plurality of optical fibers 40 in the inner hole 51 of the ferrule 50 and the first diameter portion 43 of the other optical fiber 40. The deviation is deviation between the arrangement of the plurality of optical fibers 40 at the front end 50a of the ferrule 50 and the arrangement of the plurality of optical fibers 40 in the inner hole 61. The deviation is deviation of a predetermined angle or more along the circumferential direction around the central axis L1 of the inner hole 51. The predetermined angle is, for example, 90 degrees. The deviation generated when the plurality of optical fibers 40 rotate together is referred to as torsion.

Hereinafter, the determining step (Step S06) will be described in more detail. First, based on the appearance of the coating 42 of the optical fiber 40, the correspondence relationship between the coating portions 46 of the plurality of optical fibers 40 at the rear end 50b of the ferrule 50 and the terminal end surfaces 40d of the plurality of optical fibers 40 is confirmed. Next, the correspondence relationship between the terminal end surface 40d and the tip surface 40c confirmed in Step S05 is applied to the correspondence relationship between the coating portion 46 in the flange 60 and the terminal end surface 40d, thereby confirming the correspondence relationship between the coating portion 46 in the flange 60 and the tip surface 40c at the front end 50a of the ferrule 50.

Subsequently, based on the correspondence relationship between the coating portion 46 in the flange 60 and the tip surface 40c at the front end 50a of the ferrule 50, the arrangement of the coating portions 46 of the plurality of optical fibers 40 in the inner hole 61 (hereinafter, referred to as “coating portion arrangement”) is compared with the arrangement of the plurality of optical fibers 40 at the front end 50a of the ferrule 50 (hereinafter, referred to as “tip surface arrangement”). Finally, it is determined whether one or both of deviation and crossing occur based on the comparison result between the coating portion arrangement and the tip surface arrangement.

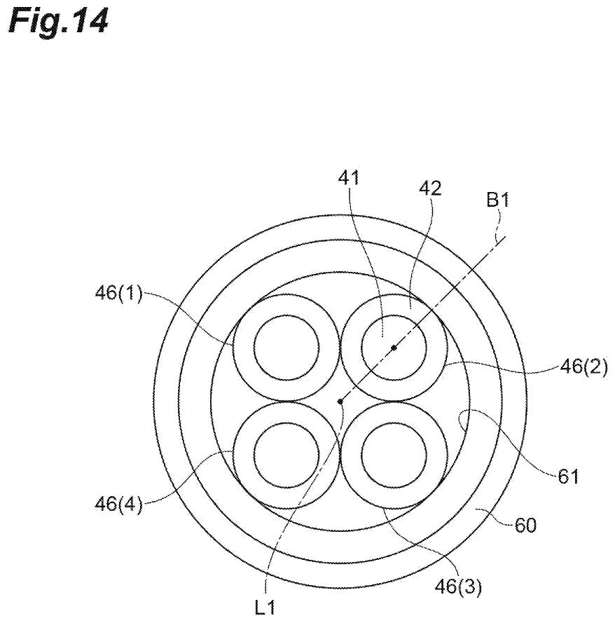

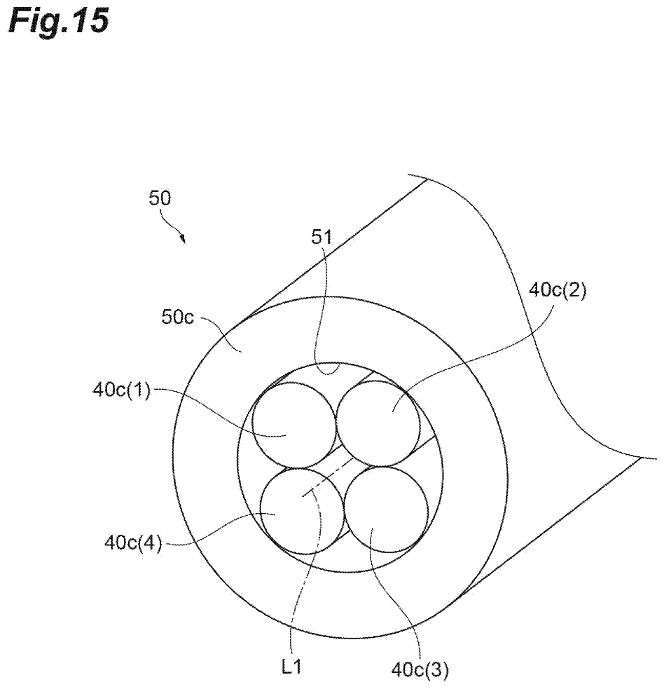

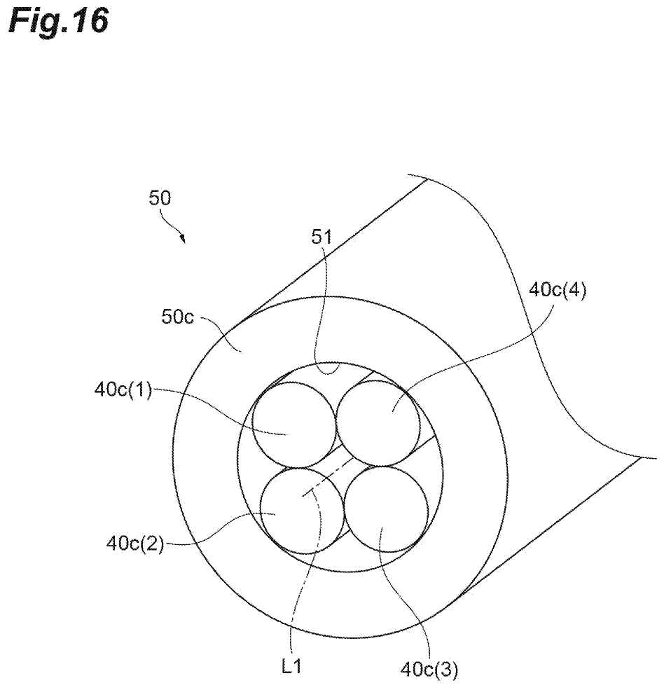

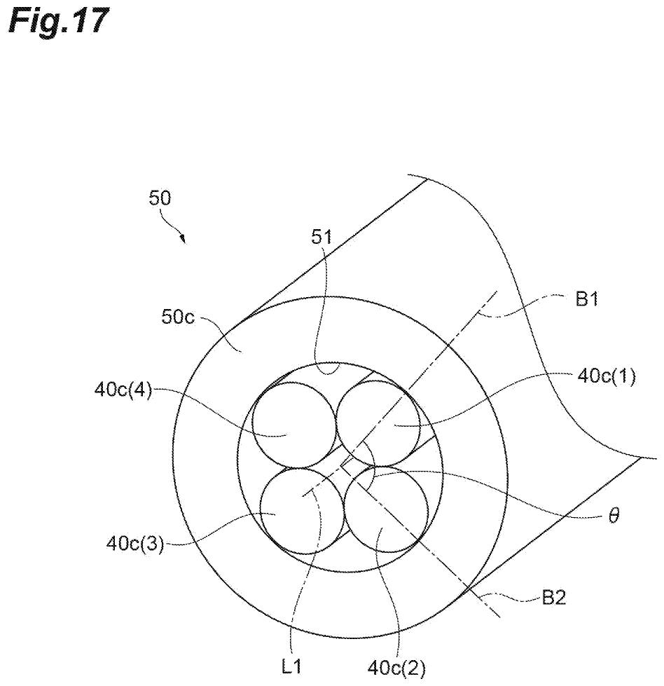

FIG. 14 is a view illustrating an example of coating portion arrangement. FIGS. 15 to 17 are views illustrating examples of the tip surface arrangement. In the example illustrated in FIG. 14, the coating portions 46(1), 46(2), 46(3), and 46(4) are arranged clockwise in this order. In the example illustrated in FIG. 15, the tip surfaces 40c(1), 40c(2), 40c(3), and 40c(4) are arranged clockwise in this order. In the example illustrated in FIG. 16, the tip surfaces 40c(1), 40c(2), 40c(3), and 40c(4) are arranged clockwise in the order of the tip surfaces 40c(1), 40c(4), 40c(3), and 40c(2). In the example illustrated in FIG. 17, the tip surfaces 40c(1), 40c(2), 40c(3), and 40c(4) are arranged clockwise in the order of the tip surfaces 40c(4), 40c(1), 40c(2), and 40c(3).

For example, when the coating portion arrangement illustrated in FIG. 14 is compared with the tip surface arrangement illustrated in FIG. 15, the clockwise arrangement order of the coating portions 46 coincides with the clockwise arrangement order of the tip surfaces 40c. In this case, it can be determined that no crossing occurs in the inner hole 51 of the ferrule 50. In addition, when the coating portion arrangement illustrated in FIG. 14 is compared with the tip surface arrangement illustrated in FIG. 15, there is no deviation along the circumferential direction around the central axis L1 of the inner hole 51 between the tip surface 40c and the coating portion 46 (in other words, the angular deviation between the tip surface 40c and the coating portion 46 is 0 degrees). In this case, in the inner hole 51 of the ferrule 50, it can be determined that no deviation in the circumferential direction around the central axis L1 occurs between the tip surface 40c and the coating portion 46. In this example, since neither the crossing of the plurality of optical fibers 40 nor the deviation between the tip surface 40c and the coating portion 46 occurs, the curvature radius of the first diameter portion 43 in the inner hole 51 of the ferrule 50 has a large value of, for example, 32.5 mm or more.

For example, when the coating portion arrangement illustrated in FIG. 14 is compared with the tip surface arrangement illustrated in FIG. 16, the clockwise arrangement order of the coating portions 46 does not coincide with the clockwise arrangement order of the tip surfaces 40c. In this case, it can be determined that crossing of the plurality of optical fibers 40 occurs in the inner hole 51 of the ferrule 50. When the coating portion arrangement illustrated in FIG. 14 is compared with the tip surface arrangement illustrated in FIG. 16, there is no deviation along the circumferential direction around the central axis L1 of the inner hole 51 between the tip surface 40c(1) and the coating portion 46(1) (in other words, the deviation between the tip surface 40c(1) and the coating portion 46(1) is 0 degrees). Similarly, no deviation along the circumferential direction around the central axis L1 of the inner hole 51 occurs between the tip surface 40c(2) and the coating portion 46(2), between the tip surface 40c(3) and the coating portion 46(3), and between the tip surface 40c(4) and the coating portion 46(4). In this case, in the inner hole 51 of the ferrule 50, it can be determined that no deviation in the circumferential direction around the central axis L1 occurs between the tip surface 40c and the coating portion 46. In this example, since the crossing of the plurality of optical fibers 40 occurs, the curvature radius of the first diameter portion 43 in the inner hole 51 of the ferrule 50 has a small value of, for example, 17.0 mm or less.

For example, when the coating portion arrangement illustrated in FIG. 14 is compared with the tip surface arrangement illustrated in FIG. 17, the clockwise arrangement order of the coating portions 46 coincides with the clockwise arrangement order of the tip surfaces 40c. In this case, it can be determined that no crossing of the plurality of optical fibers 40 occurs in the inner hole 51 of the ferrule 50. However, when the coating portion arrangement illustrated in FIG. 14 is compared with the tip surface arrangement illustrated in FIG. 17, deviation of an angle θ along the circumferential direction around the central axis L1 of the inner hole 51 occurs between the tip surface 40c and the coating portion 46. The angle θ is an angle formed by a straight line B1 and a straight line B2. The straight line B1 passes through the center of the inner hole 61 and the center of a certain coating portion 46 in FIG. 14. The straight line B2 passes through the center of the inner hole 51 and the center of the tip surface 40c in FIG. 17. In a case where the angle θ is less than the predetermined angle (for example, less than 90 degrees), it can be determined that there is no deviation between the tip surface 40c and the coating portion 46 in the inner hole 51 of the ferrule 50. In a case where the angle θ is the predetermined angle or more (for example, 90 degrees or more), it can be determined that deviation occurs between the tip surface 40c and the coating portion 46 in the inner hole 51 of the ferrule 50. In a case where the deviation of 90 degrees or more occurs, the curvature radius of the first diameter portion 43 in the inner hole 51 of the ferrule 50 has a small value of, for example, 17.0 mm or less.

In a case where it is determined that one or both of crossing and deviation occur (Step S06: YES), the inserting step (Step S04), the confirming step (Step S05), and the determining step (Step S06) are executed again. In this case, in the inserting step, the plurality of optical fibers 40 may be inserted into the ferrule 50 again. In the inserting step, vibration may be applied to the ferrule 50 without removing the plurality of optical fibers 40 from the ferrule 50. In the inserting step, the optical fiber 40 may be moved along the longitudinal direction A. In a case where it is determined that both crossing and deviation do not occur (Step S06: NO), the process proceeds to the fixing step (Step S07).

In the determining step (Step S06), only whether or not crossing occurs may be determined. In a case where it is determined that crossing occurs (Step S06: YES), the inserting step (Step S04), the confirming step (Step S05), and the determining step (Step S06) are executed again. In a case where it is determined that crossing does not occur (Step S06: NO), the process proceeds to the fixing step (Step S07). In the determining step (Step S06), only whether or not deviation occurs may be determined. In a case where it is determined that deviation occurs (Step S06: YES), the inserting step (Step S04), the confirming step (Step S05), and the determining step (Step S06) are executed again. In a case where it is determined that deviation does not occur (Step S06: NO), the process proceeds to the fixing step (Step S07).

Subsequently, the plurality of optical fibers 40 are fixed to the ferrule 50 with an adhesive (Step S07: fixing step). Specifically, first, the adhesive 28 is injected into a gap between the inner hole 51 of the ferrule 50 and the plurality of optical fibers 40. At this time, the adhesive 28 is sufficiently injected so as to cover the tip surface 40c of the optical fiber 40 and the end surface 50c of the ferrule 50. Thereafter, the adhesive 28 is thermally cured, for example, by heating. As a result, the plurality of optical fibers 40 are fixed to the ferrule 50 such that the arrangement order of the coating portions 46 in the inner hole 61 is the same as the arrangement order of the first diameter portions 43 of the plurality of optical fibers 40 at the front end 50a of the ferrule 50. Thereafter, the end surface 50c of the ferrule 50 is polished together with the tip surface 40c of the optical fiber 40. By the polishing, the adhesive on the tip surface 40c and the end surface 50c is removed, and the tip surface 40c and the end surface 50c are exposed. In a case where polishing is performed so as to enable PC connection, the curvature radius of the end surface 50c of the ferrule 50 is, for example, 1 mm or more and 50 mm or less, as described above. As described above, the optical fiber bundle 200 is prepared. Then, the second optical connector 20 is prepared by accommodating the ferrule 50 and the flange 60 in a housing (not illustrated).

Subsequently, the split sleeve 30 is prepared. Then, in the split sleeve 30, the first optical connector 10 and the second optical connector 20 are connected to each other such that the end surface 14b of the ferrule 14 and the end surface 50c of the ferrule 50 are brought into contact with each other. Subsequently, alignment is performed by rotating one or both of the ferrule 14 and the ferrule 50 in the split sleeve 30 such that each core 12a of the MCF 12 and each corresponding core 40a of the plurality of optical fibers 40 are optically coupled.

Subsequently, after the alignment is completed, the first optical connector 10 and the second optical connector 20 are fixed in a state of being pressed against each other. At this time, the ferrule 14 and the ferrule 50 may be brought into a pressed state by friction with the split sleeve 30 using a pressing member, or the ferrule 14 and the ferrule 50 may be bonded and fixed with an adhesive. As described above, the optical connection structure 1 can be manufactured.

Subsequently, a determination method for determining the states of the plurality of optical fibers 40 in the inner hole 51 of the ferrule 50 when the plurality of optical fibers 40 are inserted from the rear end 50b of the ferrule 50 into the inner hole 51 provided in the ferrule 50 will be described. First, the arrangement of the plurality of optical fibers 40 at the front end 50a of the ferrule 50 is confirmed (Step S05: confirming step). Then, it is determined whether one or both of crossing and deviation occur (Step S06: determining step).

Functions and effects obtained by the optical fiber bundle 200, the optical connection structure 1, and the method for manufacturing the optical fiber bundle 200 according to the present embodiment described above will be described. In a conventional optical fiber bundle, in a case where a plurality of optical fibers are inserted into a ferrule, the optical fibers may be deviated from each other along the longitudinal direction. In this case, since it is necessary to increase the amount of insertion of the optical fiber into the ferrule, there is a possibility that the curvatures of the plurality of optical fibers increase and bending loss in the plurality of optical fibers increases.

In the optical fiber bundle 200 according to the present embodiment, the coating 42 of the first portion 46a of the coating portion 46 of each of the plurality of optical fibers 40 is fixed to the coating 42 of the first portion 46a of the coating portion 46 of at least one optical fiber 40 among the other optical fibers 40. According to such a configuration, in the inner hole 51 and the inner hole 61, the positions of the plurality of optical fibers 40 are prevented from being deviated from each other along the longitudinal direction A. Thereby, the insertion amount of the optical fiber 40 into the ferrule 50 is suppressed from becoming excessive. As a result, an increase in the curvature of the optical fiber 40 is suppressed. In addition, an arrangement order of the coating portions 46 of the plurality of optical fibers 40 in the inner hole 61 is the same as an arrangement order of the first diameter portions 43 of the plurality of optical fibers 40 at the front end 50a of the ferrule 50. According to such a configuration, crossing of the plurality of optical fibers 40 inside the ferrule 50 is suppressed. As described above, bending loss in the plurality of optical fibers 40 can be reduced.

As in the present embodiment, the coating portion 46 of each of the plurality of optical fibers 40 includes the connecting portion 46c connecting the first portion 46a and the second portion 46b to each other. The coatings 42 of the first portions 46a of the plurality of optical fibers 40 are fixed to each other such that the first portions 46a of the plurality of optical fibers 40 are two-dimensionally arranged in the cross-section intersecting the central axis of the plurality of optical fibers 40. The coatings 42 of the second portions 46b of the plurality of optical fibers 40 are fixed to each other such that the second portions 46b of the plurality of optical fibers 40 are one-dimensionally arranged in the cross-section intersecting the central axis of the plurality of optical fibers 40. As described above, by two-dimensionally arranging the first portions 46a of the coating portions 46, it is easy to optically couple the plurality of optical fibers 40 to the plurality of cores 12a of the MCF 12. In addition, since the second portions 46b of the coating portions 46 are one-dimensionally arranged, the plurality of optical fibers 40 are prevented from being scattered and entangled with each other. As a result, when measurement or the like using the optical fiber bundle 200 is executed, workability of the measurement or the like can be improved.

As in the present embodiment, the optical fiber bundle 200 may include a protective member protecting at least the boundary 48 between the connecting portion 46c and the second portion 46b of each of the plurality of optical fibers 40. In this case, unintentional separation of the coatings 42 of the second portions 46b of the plurality of optical fibers 40 is suppressed.

As in the present embodiment, the second portions 46b of the coating portions 46 of the plurality of optical fibers 40 constitute one optical fiber ribbon. In this case, the plurality of optical fibers 40 are further prevented from being scattered and entangled with each other.

As in the present embodiment, the optical fiber ribbon has the second coating 49b collectively surrounds the coating 42 of the second portion 46b of each of the plurality of optical fibers 40. The average thickness of the second coating 49b is 0.01 mm or more and 0.25 mm or less. According to such a configuration, since the thickness of the second coating 49b is 0.01 mm or more, separation of the coatings 42 of the second portions 46b constituting the optical fiber ribbon from each other is suppressed by a sufficient strength of the second coating 49b. In addition, since the thickness of the second coating 49b is 0.25 mm or less, it is easy to remove the second coating 49b when the first portion 46a of the coating portion 46 is single-core separated.

As in the present embodiment, fixation between the coatings 42 of the first portions 46a is fixation with an adhesive. In this case, the coatings 42 can be easily fixed to each other.

As in the present embodiment, the appearance of the coating 42 of each of the plurality of optical fibers 40 includes a different color or hue for each optical fiber 40. In this case, the plurality of optical fibers 40 can be easily discriminated.

As in the present embodiment, in the plurality of optical fibers 40, positional deviation between the tapered portions 45 of the plurality of optical fibers 40 along the longitudinal direction A is 1 mm or less. In this case, an increase in the insertion amount of the optical fiber 40 into the ferrule 50 can be suppressed. As a result, an increase in the curvature of the optical fiber 40 is suppressed. As a result, bending loss in the optical fiber 40 can be reduced.

The optical connection structure 1 according to the present embodiment includes: the first optical connector 10 having the MCF 12 including the plurality of cores 12a extending along the longitudinal direction A and the cladding 12b covering the plurality of cores 12a, and the ferrule 14 holding the tip portion 12d of the MCF 12; and the second optical connector 20 having the optical fiber bundle 200. When the second optical connector 20 is connected to the first optical connector 10, the cores 40a of the plurality of optical fibers 40 are optically coupled to the plurality of cores 12a of the MCF 12, respectively. In this optical connection structure 1, bending loss in the plurality of optical fibers 40 can be reduced.

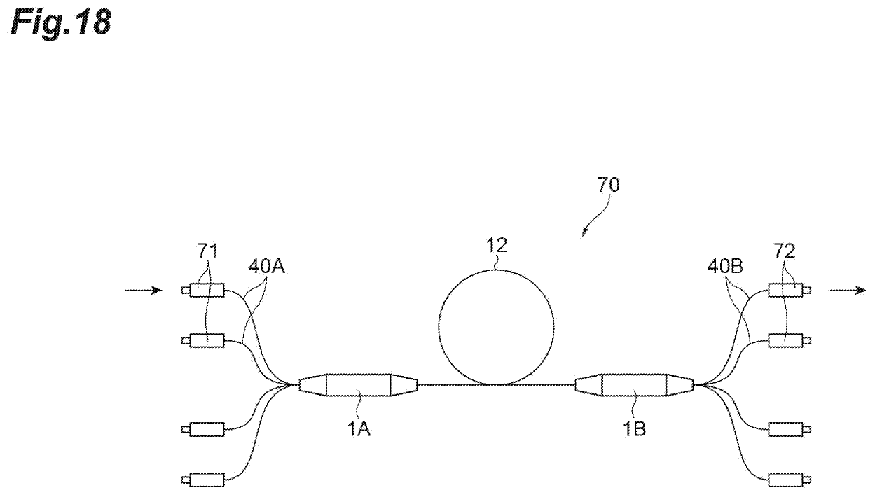

As in the present embodiment, the optical connection structure 1 optically couples the MCF 12 and the plurality of optical fibers 40. According to such a configuration, the optical connection structure 1 can constitute a fan-in/fan-out (FIFO) device of the MCF 12. FIG. 18 is a view illustrating an FIFO 70. The FIFO 70 has a plurality of connectors 71, a plurality of optical fibers 40A, an optical connection structure 1A, the MCF 12, an optical connection structure 1B, a plurality of optical fibers 40B, and a plurality of connectors 72. The plurality of connectors 71 are connected to the plurality of optical fibers 40A, respectively. The plurality of optical fibers 40A are optically coupled to the MCF 12 in the optical connection structure 1A. The MCF 12 is optically coupled to the plurality of optical fibers 40B in the optical connection structure 1B. The plurality of optical fibers 40B are optically coupled to the plurality of connectors 72. In the FIFO 70, a signal input from the connector 71 propagates through the optical fiber 40A, the MCF 12, and the optical fiber 40B and is output from the connector 72.

The optical connection structures 1A and 1B have the same configuration as in the optical connection structure 1. As a result, it is possible to easily perform alignment work, which is work of aligning the cores of the MCF 12 and the cores of the optical fibers 40A and 40B and fixing the cores at a position where the optical loss is minimized. In addition, the connectors 71 and 72 are attached to the optical connection structures 1A and 1B via the plurality of optical fibers 40A and 40B. According to such a configuration, in a case where the inspection of the FIFO 70 is performed after the alignment work, it is easy to repeatedly perform IL measurement (insertion loss measurement).

The connectors 71 and 72 are fusion-spliced to the optical fibers 40A and 40B by single-core fusion splicing or multi-core fusion splicing. In the case of performing fusion splicing by multi-core fusion splicing, the plurality of connectors 71 and 72 can be connected to the plurality of optical fibers 40A and 40B by one operation. In this case, the operation time can be shortened as compared with the single-core fusion splicing. In a case where the plurality of optical fibers 40A and 40B are optical fiber ribbons, the plurality of connectors 71 and 72 can be easily fusion-spliced to the plurality of optical fibers 40A and 40B. Since it is not necessary to arrange and fusion-splice the optical fibers 40A and 40B alone, the operation for fusion splicing is simplified, so that the manufacturing cost of the FIFO 70 can be reduced, and a decrease in fusion splicing accuracy can be suppressed.

In the method for manufacturing the optical fiber bundle 200 according to the present embodiment, the coating 42 of the first portion 46a of each of the plurality of optical fibers 40 is fixed to the coating 42 of the first portion 46a of at least one optical fiber 40 among the other plurality of optical fibers 40. According to such a configuration, in the inner hole 51 and the inner hole 61, the positions of the plurality of optical fibers 40 are prevented from being deviated from each other along the longitudinal direction A. Thereby, the insertion amount of the optical fiber 40 into the ferrule 50 can be suppressed from becoming excessive. As a result, an increase in the curvature of the optical fiber 40 is suppressed. In addition, an arrangement order of the coating portions 46 of the plurality of optical fibers 40 in the inner hole 61 is the same as an arrangement order of the first diameter portions 43 of the plurality of optical fibers 40 at the front end 50a of the ferrule 50. According to such a configuration, crossing of the plurality of optical fibers 40 inside the ferrule 50 is suppressed. As described above, it is possible to manufacture the optical fiber bundle 200 in which bending loss of a plurality of optical fibers 40 are reduced.

As in the present embodiment, in the inserting step (Step S04), the coating portions 46 of the plurality of optical fibers 40 are disposed on a jig to align and temporarily fix the plurality of optical fibers 40 in a predetermined arrangement, and the jig is removed from the plurality of optical fibers after the plurality of optical fibers 40 are inserted into the ferrule 50. In this case, since the plurality of coating portions 46 are prevented from being scattered and entangled with each other, workability of the inserting step (Step S04) is improved.

As in the present embodiment, the step of preparing the plurality of optical fibers 40 may include a step of forming the first diameter portion 43 and the tapered portion 45 by separating the plurality of optical fibers 40 from each other over a length of 10 mm or more from a tip of an optical fiber ribbon formed by integrating the plurality of optical fibers 40 and chemically etching a tip of the glass fiber 41 of each of the optical fibers 40. In this case, the first diameter portions 43 and the tapered portions 45 of the plurality of optical fibers 40 can be easily formed.

The optical fiber bundle 200, the optical connection structure 1, and the method for manufacturing the optical fiber bundle 200 according to the present disclosure are not limited to the above-described embodiments, and various other modifications are possible. In the above embodiment, the coating 42 of the second portion 46b of each of the plurality of optical fibers 40 is fixed to the coating 42 of the second portion 46b of the other optical fiber 40, but the present disclosure is not limited thereto. For example, the coatings 42 of the second portions 46b of the plurality of optical fibers 40 may be separated from each other. Even in this case, since the first portions 46a of the plurality of optical fibers 40 are fixed to each other, the positions of the plurality of optical fibers 40 are prevented from being deviated from each other along the longitudinal direction. As a result, an increase in the curvature of the plurality of optical fibers 40 is suppressed.

In the above embodiment, the first portions 46a are two-dimensionally arranged in the cross-section intersecting the central axis of the plurality of optical fibers 40, and the second portions 46b are one-dimensionally arranged in the cross-section intersecting the central axis of the plurality of optical fibers 40, but the present disclosure is not limited thereto. For example, the whole of the coating portions 46 of the plurality of optical fibers 40 may be two-dimensionally arranged in the cross-section intersecting the central axis of the plurality of optical fibers 40. The coating 42 of each of the plurality of optical fibers 40 may be fixed to the coating 42 of at least one optical fiber 40 among other adjacent optical fibers 40. Even in this case, the positions of the plurality of optical fibers 40 are prevented from being deviated from each other along the longitudinal direction A. As a result, an increase in the curvature of the plurality of optical fibers 40 is further suppressed.

In the above embodiment, the optical fiber bundle 200 may further include a cylindrical body extending along the longitudinal direction A. Then, the first portion 46a of each of the plurality of optical fibers 40 may be inserted into the inside of the cylindrical body, and the coating 42 of the first portion 46a may be fixed to the cylindrical body with an adhesive. In this case, the coatings 42 of the plurality of first portions 46a can be firmly fixed to each other.

In the above embodiment, the optical fiber bundle 200 may further include a tubular shrink tube extending along the longitudinal direction A. The first portions 46a of the plurality of optical fibers 40 may be housed and collectively held in the shrink tube. In this case, the coatings 42 of the plurality of first portions 46a can be firmly fixed to each other.

In the above embodiment, the appearance of the coating of each of the plurality of optical fibers 40 includes a different color or hue for each optical fiber, but may include the same color or the same hue.

What is claimed is:

1. An optical fiber bundle for optically coupling a plurality of optical fibers to a multicore optical fiber, the optical fiber bundle comprising:
a ferrule extending along a first direction, the ferrule having a front end in the first direction, a rear end opposite to the front end in the first direction, and a first fiber accommodating hole as a hole including a first portion that is located at the front end, a second portion that is located at the rear end and has a larger inner diameter than an inner diameter of the first portion, and an inner diameter transition portion that connects the first portion and the second portion to each other;
a holding portion having a second fiber accommodating hole as a hole extending along the first direction and communicating with the first fiber accommodating hole at the rear end of the ferrule; and
a plurality of optical fibers each having a glass fiber and a coating portion, the glass fiber including a first diameter portion, a second diameter portion having a larger diameter than a diameter of the first diameter portion, and a tapered portion connecting the first diameter portion and the second diameter portion, at least the first diameter portion, the tapered portion, and the second diameter portion extending along the first direction, and the coating portion being formed by covering a glass fiber continuous with the second diameter portion with a coating, wherein
the first diameter portion of each of the plurality of optical fibers is inserted into the first portion of the first fiber accommodating hole,
the tapered portion of each of the plurality of optical fibers is inserted into the second portion of the first fiber accommodating hole,
a boundary between the second diameter portion of each of the plurality of optical fibers and the coating portion of each of the plurality of optical fibers is inserted into the second fiber accommodating hole,
the coating portion of each of the plurality of optical fibers includes a first portion led out from the second fiber accommodating hole and a second portion away from the second fiber accommodating hole, and the coating of the first portion of the coating portion of each of the plurality of optical fibers is fixed to the coating of the first portion of the coating portion of at least one optical fiber among other optical fibers, and
in the second fiber accommodating hole, an arrangement order of coating portions, each of the coating portions being the coating portion of each of the plurality of optical fibers, is same as an arrangement order of first diameter portions, each of the first diameter portions being the first diameter portion of each of the plurality of optical fibers, at the front end of the ferrule.

2. The optical fiber bundle according to claim 1, wherein first portions, each of the first portions being the first portion of the coating portion of each of the plurality of optical fibers, are integrated by coatings fixed to each other, each of the coatings being the coating, and
in second portions, each of the second portions being the second portion of the coating portion of each of the plurality of optical fibers, the coatings are separated from each other.

3. The optical fiber bundle according to claim 1, wherein first portions, each of the first portions being the first portion of the coating portion of each of the plurality of optical fibers, are two-dimensionally arranged in a cross-section intersecting a central axis of the plurality of optical fibers, and
the coating of the second portion of the coating portion of each of the plurality of optical fibers is fixed to the coating of the second portion of the coating portion of at least one optical fiber among other adjacent optical fibers.

4. The optical fiber bundle according to claim 1, wherein the coating portion of each of the plurality of optical fiber further includes a connecting portion connecting the first portion and the second portion to each other,
coatings, each of the coatings being the coating of the first portion of the coating portion of each of the plurality of optical fibers, are fixed to each other such that first portions, each of the first portions being the first portion of the coating portion of each of the plurality of optical fibers, are two-dimensionally arranged in a cross-section intersecting a central axis of the plurality of optical fibers, and
coatings, each of the coatings being the coating of the second portion of the coating portion of each of the plurality of optical fibers, are fixed to each other such that second portions, each of the second portions being the second portion of the coating portion of each of the plurality of optical fibers, are one-dimensionally arranged in the cross-section intersecting the central axis of the plurality of optical fibers.

5. The optical fiber bundle according to claim 4, further comprising a protective member protecting at least a boundary between the connecting portion and the second portion of the coating portion of each of the plurality of optical fibers.

6. The optical fiber bundle according to claim 4, wherein the second portions constitute one optical fiber ribbon.

7. The optical fiber bundle according to claim 6, wherein the optical fiber ribbon has an other coating collectively surrounding the coatings of the second portions, and
an average thickness of the other coating is 0.01 mm or more and 0.25 mm or less.

8. The optical fiber bundle according to claim 1, wherein fixation between coatings, each of the coatings being the coating of the first portion of the coating portion of each of the plurality of optical fibers, is fixation with an adhesive.

9. The optical fiber bundle according to claim 1, further comprising
a cylindrical body extending along the first direction, wherein
the first portion of the coating portion of each of the plurality of optical fibers is inserted into the cylindrical body, and the coating of the first portion of the coating portion is fixed to the cylindrical body with an adhesive.

10. The optical fiber bundle according to claim 1, further comprising
a tubular shrink tube extending along the first direction, wherein
first portions, each of the first portions being the first portion of the coating portion of each of the plurality of optical fibers, are housed and collectively held in the tubular shrink tube.

11. The optical fiber bundle according to claim 1, wherein an appearance of the coating of each of the plurality of optical fibers includes a different color or hue for each optical fiber.

12. The optical fiber bundle according to claim 1, wherein positional deviation along the first direction between tapered portions, each of the tapered portions being the tapered portion of each of the plurality of optical fibers, is 1 mm or less.

13. An optical connection structure comprising:
a first optical connector having a multicore optical fiber including a plurality of cores extending in the first direction and a cladding covering the plurality of cores, and a ferrule holding a tip of the multicore optical fiber; and
a second optical connector as an optical connector having the optical fiber bundle according to claim 1, wherein
when the second optical connector is connected to the first optical connector, each core of the plurality of optical fibers is optically coupled to each of the plurality of cores of the multicore optical fiber.

14. A method for manufacturing an optical fiber bundle for optically coupling a plurality of optical fibers to a multicore optical fiber, the method comprising:
preparing a ferrule extending along a first direction, the ferrule having a front end in the first direction, a rear end opposite to the front end in the first direction, and a first fiber accommodating hole as a hole including a first portion that is located at the front end, a second portion that is located at the rear end and has a larger inner diameter than an inner diameter of the first portion, and an inner diameter transition portion that connects the first portion and the second portion to each other;
preparing a holding portion having a second fiber accommodating hole as a hole extending along the first direction and communicating with the first fiber accommodating hole at the rear end of the ferrule;
preparing a plurality of optical fibers each having a glass fiber and a coating portion, the glass fiber including a first diameter portion, a second diameter portion having a larger diameter than a diameter of the first diameter portion, and a tapered portion connecting the first diameter portion and the second diameter portion, at least the first diameter portion, the tapered portion, and the second diameter portion extending along the first direction, and the coating portion being formed by covering a glass fiber continuous with the second diameter portion with a coating;
inserting the first diameter portion of each of the plurality of optical fibers, the tapered portion of each of the plurality of optical fibers, and a boundary between the second diameter portion of each of the plurality of optical fibers and the coating portion of each of the plurality of optical fibers into the first portion of the first fiber accommodating hole, the second portion of the first fiber accommodating hole, and the second fiber accommodating hole, respectively; and
fixing the plurality of optical fibers to the ferrule with an adhesive, wherein
in the preparing the plurality of optical fibers, the coating portion of each of the plurality of optical fibers includes a first portion led out from the second fiber accommodating hole and a second portion away from the second fiber accommodating hole, and the coating of the first portion of each of the plurality of optical fibers is fixed to the coating of the first portion of the coating portion of at least one optical fiber among other optical fibers, and
in the fixing the plurality of optical fibers, in the second fiber accommodating hole, an arrangement order of coating portions, each of the coating portions being the coating portion of each of the plurality of optical fibers, is same as an arrangement order of first diameter portions, each of the first diameter portions being the first diameter portion of each of the plurality of optical fibers, at the front end of the ferrule.

15. The method for manufacturing an optical fiber bundle according to claim 14, wherein in the inserting, the coating portions are disposed on a jig to align and temporarily fix the plurality of optical fibers in a predetermined arrangement, and the jig is removed from the plurality of optical fibers after the plurality of optical fibers are inserted into the ferrule.

16. The method for manufacturing an optical fiber bundle according to claim 14, wherein the preparing the plurality of optical fibers includes forming the first diameter portion and the tapered portion by separating the plurality of optical fibers from each other over a length of 10 mm or more from a tip of an optical fiber ribbon formed by integrating the plurality of optical fibers and chemically etching a tip of the glass fiber of each of the optical fibers.
